(19) United States
(12) Patent Application Publication
(10) Pub. No.: US 2022/0266900 A1
(43) Pub. Date: Aug. 25, 2022

(54) VEHICLE CONTROL DEVICE AND VEHICLE

(71) Applicant: HONDA MOTOR CO., LTD., Tokyo (JP)

(72) Inventors: Kentaro KASUYA, Tokyo (JP); Hiroyuki TOKUNAGA, Tokyo (JP); Shuichi OKADA, Tokyo (JP)

(21) Appl. No.: 17/675,586

(22) Filed: Feb. 18, 2022

(30) Foreign Application Priority Data
Feb. 25, 2021 (JP) 2021-028984

(51) Int. Cl. B62D 6/00

(52) U.S. Cl. CPC B62D 6/003; B62D 15/025

(57) ABSTRACT

The present invention includes: a camera that captures a vehicle forward-view image; a reference line recognizer that recognizes at least one reference line from the vehicle forward-view image; a calculator that calculates a yaw angle of a host vehicle with respect to the reference line; a vehicle controller that calculates a torque command value which generates a yaw in such a direction that the yaw angle with respect to the reference line decreases as the yaw angle increases; and a steering controller that controls the yaw of the vehicle depending on the torque command value.

### CROSS-REFERENCE TO RELATED APPLICATION

This application is based upon and claims priority from the Japanese Patent Application No. 2021-028984, filed on Feb. 25, 2021, the entire contents of which are incorporated herein by reference.

### BACKGROUND OF THE INVENTION

### 1. Field of the Invention

The present invention relates to a technique for a vehicle and a vehicle control device that performs driving assist.

### 2. Description of the Related Art

There is a system that performs driving assist such as lane keep assist by applying torque to a steering system such that a vehicle can keep traveling in a lane based on vehicle-mounted camera information.

For example, JP4295138B discloses a technique of calculating a yaw rate of a vehicle by calculating a current yaw angle of a vehicle with respect to a reference line extending along a traveling road and removing an interest point change component attributable to the current yaw angle. JP4295138B discloses that such a process is performed to cancel a yaw rate generated by a steering operation by a driver and extract only a relative yaw rate component generated by disturbance such as crosswind, unevenness of a road surface, and the like.

### SUMMARY OF THE INVENTION

JP4295138B states that, after the disturbance generates the relative yaw rate, control of cancelling out this yaw rate is performed. However, in the technique disclosed in JP4295138B, a yaw angle generated by a yaw rate before the cancelling-out causes the vehicle to travel in a direction different from a traveling line before the occurrence of disturbance.

The present invention has been made in view of such background and an object of the present invention is to achieve stable traveling in a drive assist technique.

To solve the problem described above, the present invention includes: a camera that captures a vehicle forward-view image; a reference line recognizer that recognizes at least one reference line and a yaw angle of a host vehicle with respect to the reference line from the vehicle forward-view image; a recovery yaw rate calculator that calculates a recovery yaw rate which generates a yaw in such a direction that the yaw angle with respect to the reference line decreases as the yaw angle increases; and a steering controller that controls the yaw of the vehicle depending on the recovery yaw rate.

Other solving means are described as appropriate in the embodiments.

The present invention can achieve stable traveling in a drive assist technique.

### BRIEF DESCRIPTION OF THE DRAWINGS

FIG. 1 is a diagram showing a configuration of a vehicle control device according to an embodiment.

FIG. 2 is a flowchart showing a procedure of processes performed by the vehicle control device.

FIG. 3 is a diagram showing information inputted into a vehicle controller and information outputted from the vehicle controller.

FIG. 4 is a diagram showing definition of positive and negative for a yaw rate.

FIG. 5 is a diagram showing definition of positive and negative for a yaw angle.

FIG. 6 is a diagram showing a torque command value calculation map.

FIG. 7 is a diagram explaining values used in calculation of an offset.

FIG. 8 is a diagram showing behavior of a vehicle.

FIG. 9 is a diagram in which a rightward yaw angle is generated for the vehicle.

FIG. 10 is a diagram in which a leftward yaw angle is generated for the vehicle.

FIG. 11 is a graph showing an attenuation rate curve for a curvature.

FIG. 12A is a graph (part 1) showing changes of the attenuation rate curve with respect to vehicle speed.

FIG. 12B is a graph (part 2) showing changes of the attenuation rate curve with respect to the vehicle speed.

FIG. 12C is a graph (part 3) showing changes of the attenuation rate curve with respect to the vehicle speed.

FIG. 13 is a graph relating to steering control performed by the vehicle controller.

FIG. 14 is a diagram showing general behavior of the vehicle in a cant road.

FIG. 15 is a diagram explaining an integration process.

FIG. 16A is a graph (part 1) explaining a reference line recognition process.

FIG. 16B is a graph (part 2) explaining the reference line recognition process.

FIG. 17 is a diagram showing a detailed configuration of the vehicle controller according to a first embodiment.

FIG. 18 is a flowchart showing a procedure of processes performed by the vehicle controller.

FIG. 19 is a diagram showing a detailed configuration of a vehicle controller according to a second embodiment.

### DETAILED DESCRIPTION OF THE EMBODIMENTS

Next, a mode for carrying out the present invention (referred to as “embodiment”) is described in detail with reference to the drawings as appropriate. The embodiment is a technique applied in a driving assist technique of assisting a straight running performance of a vehicle.

### (Vehicle Control Device 1)

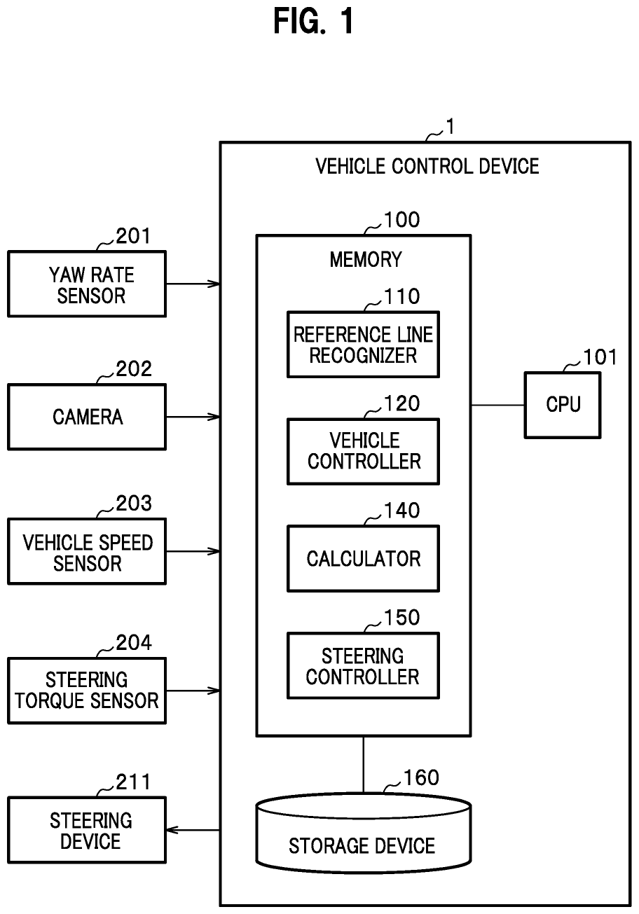

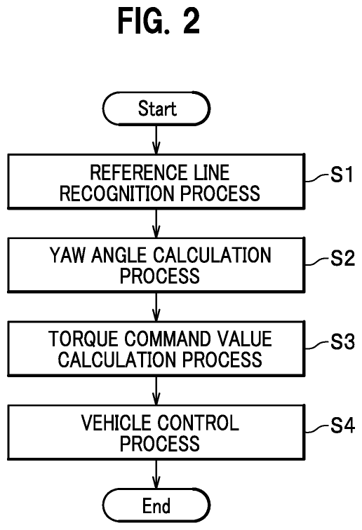

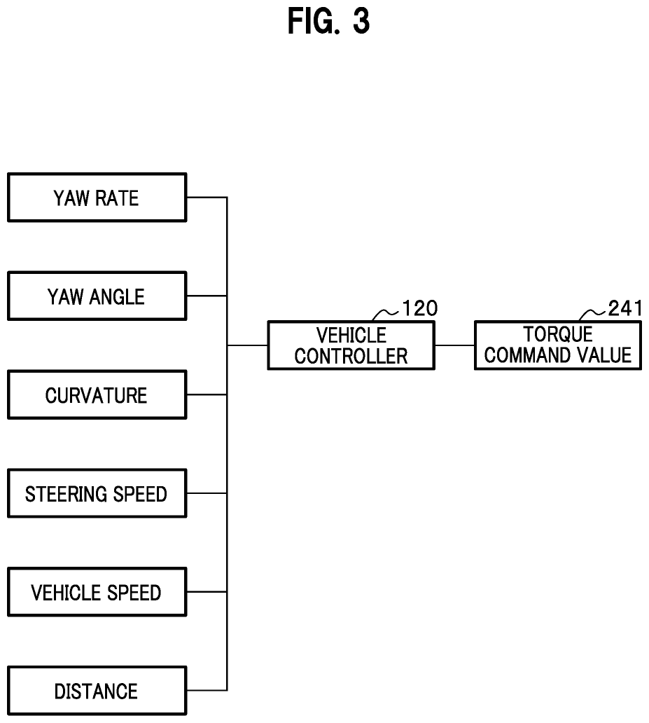

FIG. 1 is a diagram showing a configuration of a vehicle control device 1 according to the embodiment. FIG. 2 is a flowchart showing a procedure of processes performed by the vehicle control device 1. FIG. 3 is a diagram showing information inputted into a vehicle controller 120 and information outputted from the vehicle controller 120.

The vehicle control device 1 is mounted in an engine control unit (ECU). The vehicle control device 1 includes a memory 100, a central processing unit (CPU) 101, and a storage device 160. In this example, the memory 100 is formed of a read-only memory (ROM) and the like. Moreover, the storage device 160 is formed of a random access memory (RAM) and the like.

As shown in FIG. 1, the vehicle control device 1 calculates a torque command value 241 (see FIG. 3) for controlling a steering device 211, by using information obtained from a yaw rate sensor 201, a camera 202, a vehicle speed sensor 203, and a steering torque sensor 204. Moreover, the vehicle control device 1 controls the steering device 211 based on the calculated torque command value 241. Driving assist for driving by a driver is thereby performed.

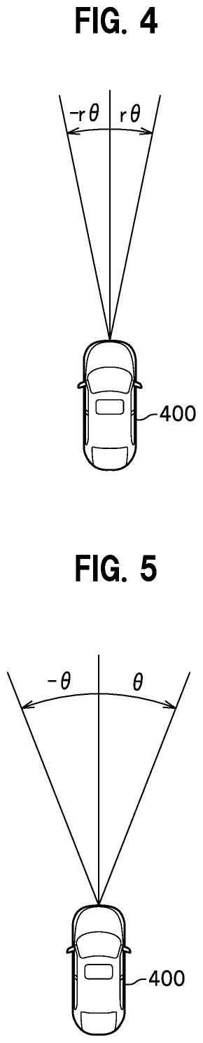

The yaw rate sensor 201 detects an angular velocity of a vehicle 400 (see FIG. 4 and the like) about a vertical axis.

Moreover, the camera 202 captures at least a forward-view of the vehicle 400.

The vehicle speed sensor 203 detects the speed of the vehicle 400.

The steering torque sensor 204 detects torque applied to a not-shown steering wheel and outputs a steering torque signal indicating the detection result.

Furthermore, the steering device 211 includes a steering ECU, an electric motor, and the like that are not shown. The electric motor changes a direction of the steering wheel by, for example, applying force to a rack-and-pinion mechanism. The steering ECU drives the electric motor according to a steering command received from the vehicle control device 1 or information received from the steering wheel and causes the electric motor to change the direction of the steering wheel.

The CPU 101 executes a program stored in the memory 100 and a reference line recognizer 110, the vehicle controller 120, a calculator 140, and a steering controller 150 are thereby implemented.

Processes performed by the reference line recognizer 110, the calculator 140, the vehicle controller 120, and the steering controller 150 are described below with reference to FIGS. 1 and 2. Step numbers in the following description indicate the step numbers in FIG. 2.

The reference line recognizer 110 performs a reference line recognition process of recognizing a reference line LS (see FIG. 7) such as a white line or a center line on a lane based on a video captured by the camera 202 or the like (51). The reference line LS is described later.

The calculator 140 performs a yaw angle calculation process of calculating a tilt (yaw angle) of the host vehicle (vehicle 400 (see FIG. 4 and the like)) with respect to the reference line LS recognized by the reference line recognizer 110 (S2).

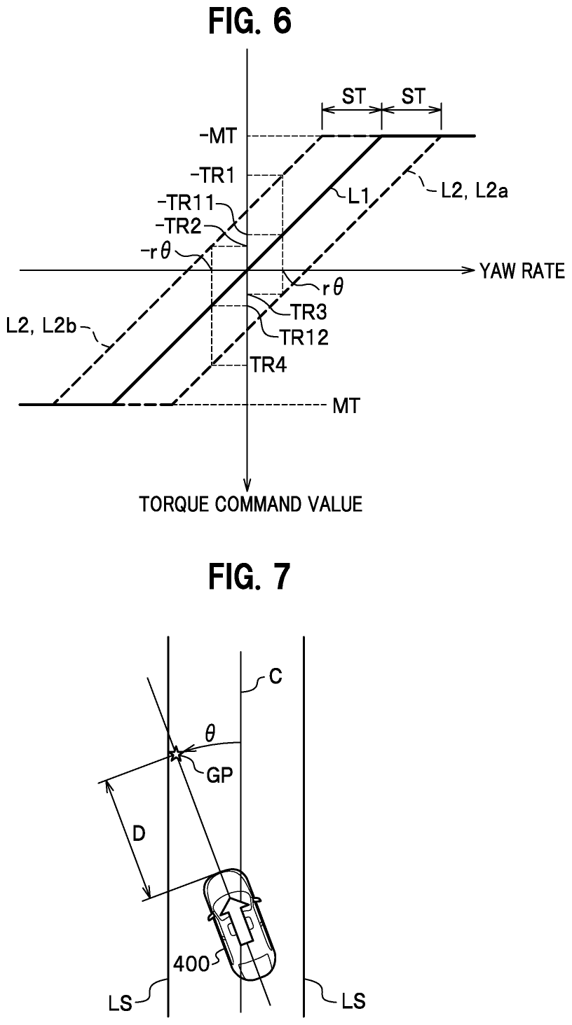

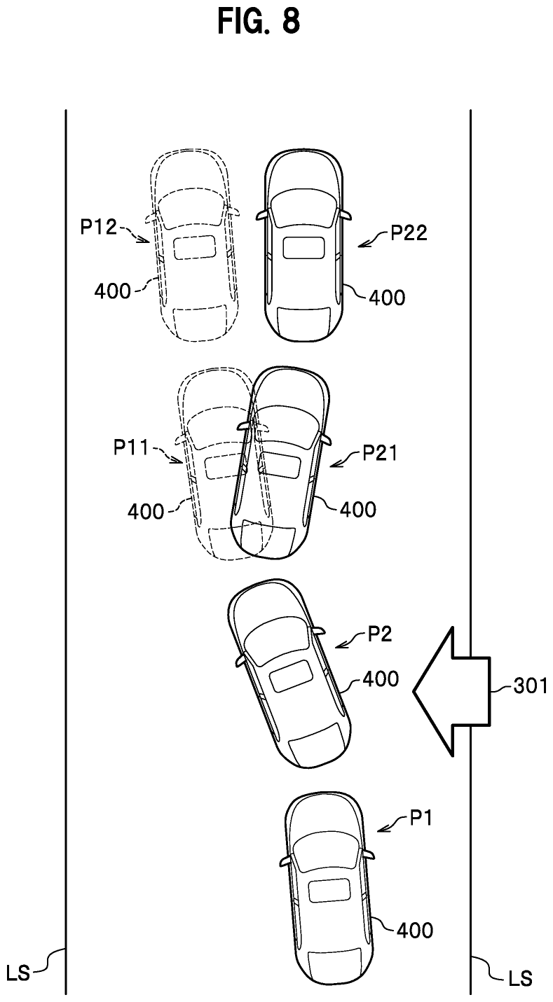

The vehicle controller 120 performs a torque command value calculation process of calculating the torque command value 241 (recovery yaw rate) when the yaw rate sensor 201 detects generation of a yaw rate in the vehicle 400 due to disturbance 301 (see FIG. 8) or the like (S3). The torque command value 241 is a command value for generating torque that causes the vehicle 400 to become parallel to the reference line LS, in the steering device 211 as will be described later. As shown in FIG. 3, when the generation of a yaw rate is detected, the vehicle controller 120 calculates an offset ST (see FIG. 6) based on the vehicle speed of the vehicle 400, a distance to a front interest point GP (see FIG. 7) to be described later, the yaw angle, and the like. In this case, the vehicle speed is speed detected by the vehicle speed sensor 203 and the yaw angle is an angle calculated by the calculator 140. Moreover, the vehicle controller 120 calculates the torque command value 241 based on the offset ST and outputs the torque command value 241. Moreover, as shown in FIG. 3, the vehicle controller 120 multiplies the offset ST by an attenuation rate depending on a curvature of a lane and multiplies the torque command value 241 by an attenuation torque depending steering speed of the steering wheel (not shown). Processes performed by the vehicle controller 120 are described later.

Thereafter, the steering controller 150 performs a vehicle control process of operating the steering device 211 based on the torque command value 241 calculated by the vehicle controller 120 (S4).

### (Definition of Positive and Negative of Angle and Yaw Rate)

In the following description, a right-hand angle and a right-hand yaw rate based on the vehicle 400 are defined as a positive angle and a positive yaw rate and a left-hand angle and a left-hand yaw rate based on the vehicle 400 are defined as a negative angle and a negative yaw rate.

FIG. 4 is a diagram showing definition of positive and negative for the yaw rate and FIG. 5 is a diagram showing definition of positive and negative for the yaw angle.

Specifically, as shown in FIG. 4, a right-hand yaw rate based on the vehicle 400 is defined as (+)rθ and a left-hand yaw rate is defined as −rθ. Moreover, as shown in FIG. 5, a right-hand yaw angle based on the vehicle 400 is defined as (+)θ and a left-hand yaw angle is defined as −θ.

### (Torque Command Value Calculation Process)

Details of the torque command value calculation process (step S3 of FIG. 2) are described below.

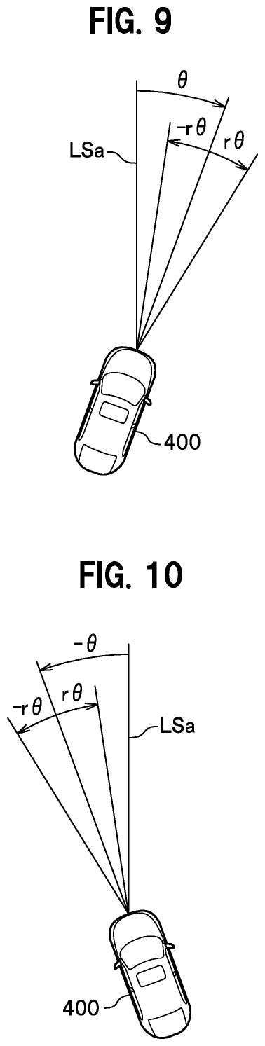

Before the vehicle controller 120 performs the torque command value calculation process, the reference line recognizer 110 recognizes the yaw angle (azimuth deviation) of the host vehicle (vehicle 400) with respect to the reference line LS based on an image obtained from the camera 202 as described above. A line LSa (see FIG. 9) is assumed to be a line that is parallel to the reference line LS (see FIG. 7) and that passes the center of the vehicle 400. In this case, the reference line LS is a line parallel to a white line, a center line, or the like in a lane.

The calculator 140 inputs the recognized yaw angle into the vehicle controller 120.

The vehicle controller 120 calculates the torque command value 241 based on the yaw angle.

### (Torque Command Value Calculation Process)

Next, processes performed in the torque command value calculation process (S3 of FIG. 2) are described with reference to FIGS. 6 to 16B.

FIG. 6 is a diagram showing a torque command value calculation map.

In FIG. 6, the horizontal axis represents the yaw rate detected by the yaw rate sensor 201 of the vehicle 400. Moreover, the vertical axis represents the torque command value 241 outputted to the steering controller 150. Furthermore, the solid line L1 in FIG. 6 shows a torque command value calculation map in the case where the yaw angle is not taken into consideration. Meanwhile, the broken lines L2 show torque command value calculation maps in the case where the yaw angle is taken into consideration. As described above, when the yaw rate takes a positive value, the yaw rate is a right-hand yaw rate based on the vehicle 400. When the yaw rate takes a negative value, the yaw rate is a left-hand yaw rate based on the vehicle 400. Since the torque command value 241 is reaction force to the yaw rate, the torque command value 241 is negative on the upper side in the drawing and is positive on the lower side in the drawing in the vertical axis shown in FIG. 6.

As shown in FIG. 6, the solid line L1 is shown as a straight line that passes the point of yaw rate=0 and torque command value 241=0. Moreover, upper and lower limits (±MT) are provided for the torque command value 241 to prevent output of an excessive torque command value 241.

The broken lines L2 are each provided at a position shifted from the solid line L1 by the offset ST. In this case, the broken lines L2 are provided at a position shifted from the solid line L1 by the offset ST in the positive direction with respect to the horizontal axis (broken line L2a) and a position shifted from the solid line L1 by the offset ST in the negative direction with respect to the horizontal axis (broken line L2b). In this case, the offset ST is calculated by using the following formula (1).

$$ST = θ ( V / D ) \qquad ( 1 )$$

The variable and constants in the formula (1) are described with reference to FIG. 7.

θ is the yaw angle of the vehicle 400. In this case, the yaw angle (θ) is the yaw angle of the vehicle 400 with respect to the reference line LS. Note that the line C in FIG. 7 is a line that is parallel to the reference line LS and that passes the center of the vehicle 400. Moreover, the reference line LS is a line parallel to the white line, the center line, or the like in the lane as described above.

In the formula (1), V is the speed of the vehicle 400 and D is a distance between the vehicle 400 and the front interest point GP shown in FIG. 7. Note that the white arrow in FIG. 7 shows the traveling direction of the vehicle 400. In this case, D is a value determined from the current vehicle speed (changes depending on the vehicle speed). For example, the calculator 140 calculates the distance D from the current position of the vehicle 400 to the front interest point GP while setting a point that the vehicle 400 reaches 2 seconds later by traveling at the current vehicle speed in the current direction of the vehicle 400, as the front interest point GP. In the embodiment, values of D and V at a moment when the torque control is started are used, and D and V are fixed during one calculation process of the torque command value 241. Specifically, in the formula (1), D and V are constants and θ is a variable. The yaw angle (θ) can be converted to a dimension of the yaw rate by using the formula (1). Although the yaw angle (θ) is multiplied by V/D to convert the yaw angle (θ) to the dimension of the yaw rate in the formula (1), the present invention is not limited to this method as long as the yaw angle (θ) can be converted to the dimension of the yaw rate.

Next, calculation of the torque command value 241 based on the solid line L1 is described with reference to FIG. 6. In the embodiment, the process based on the solid line L1 is a process performed when the yaw angle is “0”.

When the yaw rate is generated in the vehicle 400 due to the disturbance 301 or the like, the vehicle control device 1 generates torque that cancels out the generated yaw rate, based on the solid line L1. In other words, the vehicle controller 120 outputs the torque command value 241 that cancels out the generated yaw rate. Note that, as shown in FIG. 6, the torque command value 241 is a value obtained by multiplying the generated yaw rate by a predetermined gain.

Behavior of the vehicle 400 under torque control based on the solid line L1 of FIG. 6 is described with reference to FIG. 8. Note that, in FIG. 8, the solid lines show behavior of the vehicle 400 under torque control based on the broken lines L2 of FIG. 6 and the broken lines show the behavior of the vehicle 400 under the torque control based on the solid line L1 of FIG. 6. Note that, at the positions P1 and P2 of FIG. 8, the vehicle 400 exhibits the same behavior in both of the torque control based on the solid line L1 and the torque control based on the broken lines L2, and is thus shown by the solid lines.

In this method, for example, assume that the driver has been performing a steering operation (steering) before the occurrence of the disturbance 301. For example, assume that the driver is performing a steering operation to avoid rubbish or the like on the road. Alternatively, assume that the driver is turning the steering wheel (not shown) in a direction with a small deviation angle with respect to the reference line LS due to unstable steering operation. In the example of FIG. 8, the vehicle 400 is traveling while tilting to the left in the drawing (in a state where there is a yaw angle) with respect to the reference line LS (for example, white lines on both sides of the lane) at the moment of the position P1.

Assume that the vehicle 400 receives the disturbance 301 such as crosswind in a leftward direction in the drawing (white arrow) (position P2 in FIG. 8) in such a state (position P1 in FIG. 8). As a result, the vehicle 400 tilts further to the left in the drawing from the tilted state at the position P1. Specifically, the disturbance 301 generates the leftward yaw rate in the drawing in the vehicle 400.

In the control based on the solid line L1 of FIG. 6, the vehicle controller 120 calculates the torque command value 241 based on the solid line L1 of FIG. 6. As a result, the yaw rate generated by the disturbance 301 is canceled out (positions P11 and P12 in FIG. 8). Although the yaw rate generated by the disturbance 301 is canceled out, the tilt of the vehicle 400 present before the occurrence of the disturbance 301, that is at the position P1 is not canceled out. Accordingly, the tilt of the vehicle 400 after the completion of the torque control (position P12 in FIG. 8) is the same as the tilt of the vehicle 400 before the occurrence of the disturbance 301 (position P1 in FIG. 8). Specifically, the vehicle 400 still has the tilt (yaw angle) with respect to the reference line LS at the position P12 in FIG. 8.

Next, details of calculation of the torque command value 241 based on the broken lines L2 shown in FIG. 6 are described.

As described above, the broken lines L2 include the broken line L2a and the broken line L2b.

First, calculation of the torque command value 241 in a state where a rightward yaw angle ((+)θ) is generated for the vehicle 400 is described with reference to FIGS. 9 and 6.

FIG. 9 is a diagram showing a state where a rightward yaw angle ((+)θ) is generated for the vehicle 400. Note that, since the dimension of the yaw angle (θ) is different from the dimension of the yaw rate (rθ), it is not appropriate to handle the yaw angle and the yaw rate in the same way in ordinary circumstances. However, in order to simplify the description, the yaw angle and the yaw rate are handled in the same way. Moreover, the line LSa is a line parallel to the reference line LS (see FIG. 7).

When a rightward yaw angle ((+)θ) is generated as in FIG. 9, the vehicle controller 120 calculates the torque command value 241 by using the broken line L2b in FIG. 6. Assume that a rightward yaw rate ((+)rθ) is further generated for the vehicle 400 in the state of the yaw angle ((+)θ) shown in FIG. 9. In this case, the torque command value 241 calculated from the broken line L2b in FIG. 6 is −TR1. Note that, since the torque command value 241 is the reaction force to the generated yaw rate as described above, the torque command value 241 is a negative value in this case. The absolute value (|TR1|) of −TR1 is a value larger than the absolute value (|TR11|) of the torque command value 241 (−TR11) obtained from the solid line L1 with reference to FIG. 6. This means that a deviation angle corresponding to the yaw angle ((+)θ) is corrected together with the yaw angle ((+)rθ) generated by the disturbance 301.

The tilt of the vehicle 400 can be thereby returned to a position aligned with the line LSa (yaw angle=“0”), from the state where the yaw rate ((+)rθ) generated by the disturbance 301 is further added to the yaw angle ((+)θ) of FIG. 9.

Next, assume that a leftward yaw rate (−rθ) is further generated for the vehicle 400 in the state of the yaw angle ((+)θ) shown in FIG. 9. In such a case, the torque command value 241 calculated from the broken line L2b of FIG. 6 is −TR2. With reference to FIG. 6, −TR2 is a negative value. Meanwhile, the value ((+)TR12) of the solid line L1 corresponding to the yaw rate (−rθ) is a positive value. This indicates that, since the solid line L1 outputs the torque command value 241 to cancel out the generated negative yaw rate, the positive torque command value 241 is outputted. Meanwhile, in the control using the broken line L2b, the torque command value 241 is outputted to cancel out the yaw angle having the positive value in addition to the negative yaw rate. In this example, since a deviation angle due to the generated negative yaw rate is smaller than the positive yaw angle, the negative torque command value 241 as a whole is outputted.

Such a control allows the tilt of the vehicle 400 to return to the position aligned with the line LSa (yaw angle=“0”) from the state where the yaw rate (−)rθ generated by the disturbance 301 is further added to the yaw angle (+)θ of FIG. 9.

Next, calculation of the torque command value 241 in a state where a leftward yaw angle ((−)θ) is generated for the vehicle 400 is described with reference to FIGS. 10 and 6.

FIG. 10 is a diagram showing a state where a leftward yaw angle (−θ) is generated for the vehicle 400.

When a leftward yaw angle (−θ) is generated as in FIG. 10, the vehicle controller 120 calculates the torque command value 241 by using the broken line L2a in FIG. 6. Assume that a leftward yaw rate (40) is further generated for the vehicle 400 in the state of the yaw angle (−θ) shown in FIG. 10. In this case, the torque command value 241 calculated from the broken line L2a in FIG. 6 is (+)TR4. With reference to FIG. 6, TR4 is a value larger than the torque command value 241 (TR12) obtained from the solid line L1 for the yaw rate (−rθ). This means that a deviation angle corresponding to the yaw angle (−θ) is corrected together with the yaw angle (−rθ) generated by the disturbance 301.

The tilt of the vehicle 400 can be thereby returned to the position aligned with the line LSa (yaw angle=“0”) from the state where the yaw rate (−rθ) generated by the disturbance 301 is further added to the yaw angle (−θ) of FIG. 10.

Next, assume that a rightward yaw rate ((+)rθ) is further generated for the vehicle 400 in the state of the yaw angle (−θ) shown in FIG. 10. In such a case, the torque command value 241 calculated from the broken line L2a of FIG. 6 is (+)TR3. With reference to FIG. 6, (+)TR3 is a positive value but the value ((−)TR11) of the solid line L1 corresponding to the yaw rate ((+)rθ) is a negative value. This indicates that, since the solid line L1 outputs the torque command value 241 to cancel out the generated positive yaw rate, the negative torque command value 241 is outputted. Meanwhile, in the control using the broken line L2b, the torque command value 241 is outputted to cancel out the yaw angle having the negative value in addition to the positive yaw rate. In this example, since a deviation angle generated by the yaw rate is smaller than the yaw angle, the positive torque command value 241 as a whole is outputted.

Such a control allows the tilt of the vehicle 400 to return to the position aligned with the line LSa (yaw angle=“0”) from the state where the yaw rate ((+)rθ) generated by the disturbance 301 is further added to the yaw angle (−θ) of FIG. 10.

Moreover, as shown in the formula (1), the offset ST is a function of the yaw angle (θ) that is an angle between the vehicle 400 and the reference line LS. Accordingly, the offset ST decreases as the yaw angle (θ) decreases. This indicates that the broken lines L2 shown in FIG. 6 converge to the solid line L1 as the yaw angle (θ) decreases (as the tilt of the vehicle 400 becomes parallel to the reference line LS). Specifically, when the disturbance 301 occurs while the vehicle 400 is traveling parallel to the reference line LS, the vehicle controller 120 performs control based on the solid line L1.

Next, behavior of the vehicle 400 under the torque control based on the broken lines L2 of FIG. 6 is described with reference to FIG. 8. Assume that the vehicle 400 has a tilt (yaw angle) at the position P1 of FIG. 8 due to any of the reasons described above. Then, assume that the disturbance 301 such as crosswind occurs in the vehicle 400 as described above at the position P2. The vehicle controller 120 corrects the tilt corresponding to the yaw angle present at the position P1 in addition to the yaw angle generated by the disturbance 301 (position P21). The vehicle 400 can thereby eventually travel parallel to the reference line LS (position P22). As described above, the torque command value 241 is a yaw rate (recovery yaw rate) that causes the tilt (yaw angle) of the vehicle 400 to return to the tilt parallel to the reference line LS.

### (Curvature Process)

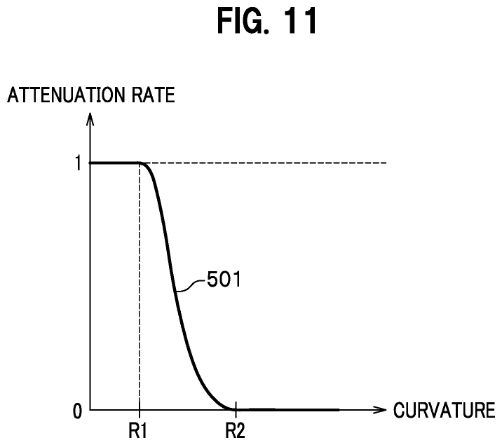

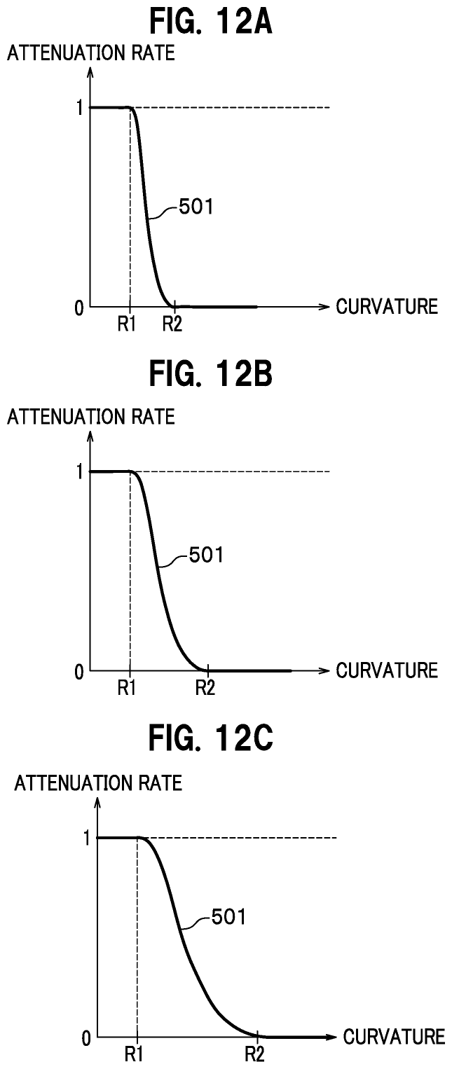

Next, adjustment of the offset ST with respect to the curvature of the lane is described with reference to FIGS. 11 to 12C.

FIG. 11 is a graph showing an attenuation rate curve 501 for the curvature.

The vehicle controller 120 multiplies the offset ST by an attenuation rate depending on the curvature of the lane. The curvature and the attenuation rate have a relationship of the attenuation rate curve 501 shown in FIG. 11. The curvature is a curvature of a curve, specifically, a curvature of a road shoulder (or a white line on the road shoulder side). As shown in FIG. 11, the attenuation rate takes a value from 0 to 1. Moreover, the attenuation rate is a value that decreases as the curvature of the lane increases as shown in FIG. 11. Specifically, as shown in FIG. 11, the attenuation rate=1 (that is, the offset ST is not attenuated) up to a predetermined curvature R1. Then, the attenuation rate is attenuated at a proportion shown in FIG. 11 when the curvature is equal to or higher than the predetermined curvature R1. Then, the attenuation rate=0 when the curvature is equal to or higher than a predetermined curvature R2 (>R1).

Multiplying the offset ST by the attenuation rate as shown in FIG. 11 prevents the control using the offset ST from being performed in a curve with a large curvature. Specifically, in a curve with a curvature larger than a predetermined value (R2 in the example shown in FIG. 11), the vehicle controller 120 outputs the torque command value 241 based on the solid line L1 in FIG. 6.

In other words, the control of the offset ST is performed only in a straight traveling road with a curvature equal to or smaller than a predetermined value. The control using the offset ST is thereby not performed in a curve in which the reference line LS itself and the shape of a road shoulder are curved. The stability of the vehicle control using the torque command value 241 can be thereby improved.

Moreover, in locations such as a location where there is a branching lane in an expressway or the like, the road shoulder sometimes changes (the lane width increases) while the center line remains as a straight line. In such a case, the road shoulder (or the white line on the road shoulder side) changes to have a certain curvature while the center line remains as a straight line. According to the embodiment, the offset ST is multiplied by the attenuation rate as shown in FIG. 11 and this prevents the control using the offset ST from being affected by the curvature of the road shoulder. The straight running stability can be thereby improved.

Furthermore, the attenuation rate is smoothly attenuated from attenuation rate=1 to attenuation rate=0 as in FIG. 11. This causes the offset ST to gradually decrease as the vehicle 400 enters a curve. Specifically, the control amount using the offset ST gradually decreases as the vehicle 400 enters a curve, and a proportion of the driver's authority to steer the vehicle can be thus naturally increased.

FIGS. 12A to 12C are graphs showing changes of the attenuation rate curve with respect to the vehicle speed.

As shown in FIGS. 12A to 12C, the attenuation rate curve 501 may be changed depending on the vehicle speed of the vehicle 400. FIG. 12A shows the case where the vehicle speed is high (fast) and FIG. 12C shows the case where the vehicle speed is low (slow). The vehicle speed in the attenuation rate shown in FIG. 12B is in the middle of the vehicle speed in the attenuation rate of FIG. 12A and the vehicle speed in the attenuation rate shown in FIG. 12C.

As shown in FIGS. 12A to 12C, the higher the vehicle speed is, the more quickly the attenuation rate is attenuated. To put it the other way around, the lower the vehicle speed is, the more slowly the attenuation rate is attenuated. When the vehicle speed is high, time the vehicle 400 takes to turn at a curve and time the vehicle 400 takes to reach a location where the curvature of the road shoulder changes such as a location where a branching line of an expressway starts are short. Accordingly, as shown in FIGS. 12A to 12C, the higher the vehicle speed of the vehicle 400 is, the more quickly the attenuation rate is attenuated. The proportion of the driver's authority to steer the vehicle can be thereby increased depending on the vehicle speed.

### (Steering Control)

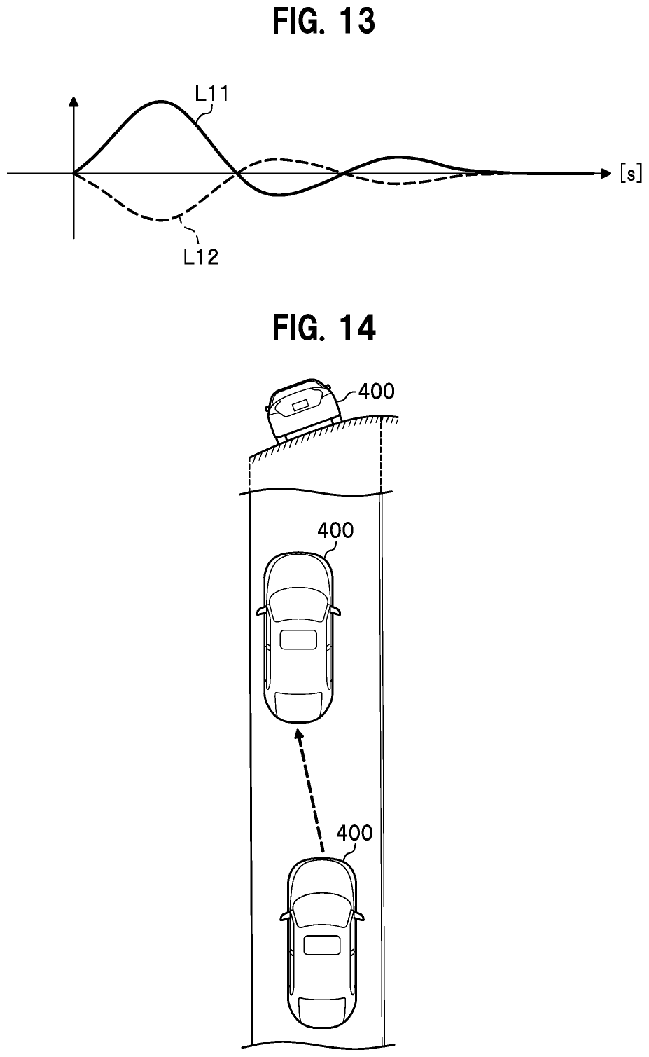

FIG. 13 is a graph relating to steering control performed by the vehicle controller 120.

In FIG. 13, the solid line L11 is a steering angular velocity (rotation speed of the steering wheel (not shown)) inputted into the vehicle controller 120. The steering angular velocity is detected by the steering torque sensor 204.

Moreover, in FIG. 13, the broken line L12 is an attenuation torque command value (attenuation torque) added to the torque command value 241 by the vehicle controller 120. As shown in FIG. 13, the attenuation torque command value is outputted as reaction force to the torque of the steering wheel. Note that the absolute value of the attenuation torque command value (broken line L12) is smaller than the absolute value of the torque (solid line L11) of the steering wheel.

When the torque control of the torque command value calculation process as shown in FIG. 6 is performed, the steering wheel responds to the control of the steering device 211 using the outputted torque command value 241. This causes the driver to feel that the steering wheel suddenly moved or to have a sense of being controlled. The driver may feel that such senses are strange. In such a case, movement of the steering wheel due to the torque control of the torque command value calculation process can be suppressed by adding the attenuation torque command value (broken line L12) as shown in FIG. 13 to the torque command value 241. This can reduce strangeness felt by the driver.

Moreover, when the torque control of the torque command value calculation process as shown in FIG. 6 (hereinafter, referred to as torque control) is performed, a damper response as shown in the solid line L11 of FIG. 13 sometimes occurs in the steering wheel. Specifically, when the tilt of the vehicle 400 is to be made parallel (yaw angle “0”) to the reference line LS by the torque control, the tilt sometimes overshoots the point of the yaw angle “0”. In such a case, the torque control is repeatedly performed again. This sometimes causes the damper response as shown in the solid line L11 in the steering wheel.

When such a situation occurs, the damper response of the steering wheel can be reduced by adding the attenuation torque command value like the broken line L12 shown in FIG. 13 to the torque command value 241. The strangeness felt by the driver can be thereby reduced.

The attenuation torque command value shown in the broken line L12 may be a value depending on the vehicle speed of the vehicle 400. Specifically, the attenuation torque command value can be a value from “0” to “1”. The attenuation torque command value may be a large value (close to “1”) when the vehicle speed is high, and be a small value (close to “0”) when the vehicle speed is low. As a result, the higher the vehicle speed is, the more the strangeness felt by the driver is reduced.

### (Integration Process)

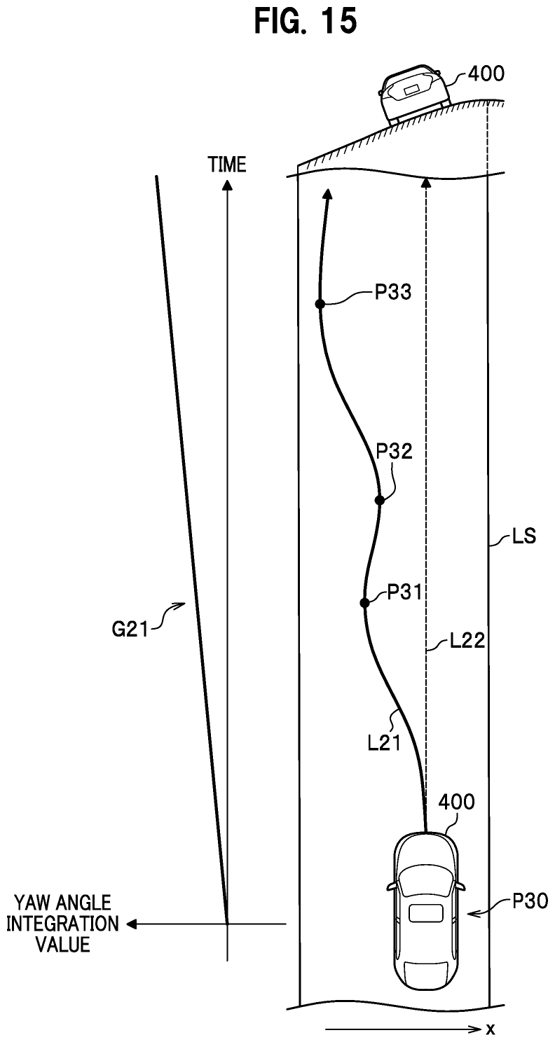

Next, an integration process performed by the vehicle controller 120 is described with reference to FIGS. 14 to 15.

FIG. 14 is a diagram showing general behavior of the vehicle 400 in a cant road.

As shown in FIG. 14, in the cant road provided with a tilt between the outer side and the inner side of a lane, side-slip of the vehicle 400 occurs. Note that the left side in the drawing of FIG. 14 is assumed to be the inner side of the lane and the right side in the drawing is assumed to be the outer side of the lane.

FIG. 15 is a diagram explaining the integration process.

When the torque control shown in FIG. 6 is performed in such a cant road, the vehicle 400 exhibits behavior as shown by the solid line L21 in FIG. 15. Specifically, when side-slip (that is, generation of the yaw rate by the disturbance 301) is detected at the position P31, the torque control shown in FIGS. 6 to 8 is performed. As a result, the tilt of the vehicle 400 becomes parallel to the reference line LS at the position P32. However, when the tilt becomes parallel to the reference line LS at the position P32, the torque control is stopped. As a result, side-slip occurs again and the torque control is performed again at the position P33. This is repeated and the vehicle 400 thereby exhibits the behavior as shown by the solid line L21 of FIG. 15. Assume that a direction traversing the lane is an x-axis as shown in FIG. 15. In this case, the x coordinate of a location (position P32 or the like) where the vehicle 400 becomes parallel to the reference line LS does not match the x coordinate of the initial position P30 in FIG. 15. Note that the broken line arrow shows a line that is parallel to the reference line LS and that passes the center of the vehicle 400 at the position P30.

When the torque control is performed for the disturbance 301 that is steadily applied like the cant road, the vehicle 400 slips sideways while swaying in the x-axis direction as in the solid line L21 of FIG. 15.

To counter such a phenomenon, the vehicle controller 120 calculates an integration value of the yaw angle generated by the disturbance 301 due to the cant road, multiples the integration value by a predetermined gain, and adds the resultant value to the torque command value 241. Note that the gain is assumed to be a negative value.

The graph G21 of FIG. 15 is a graph showing the integration value (time integration value) of the yaw angle generated in the vehicle 400 in the cant road. The vehicle controller 120 adds a value, obtained by multiplying the integration value of the yaw angle shown in the graph G21 of FIG. 15 by the gain, to the torque command value 241. The straight running performance of the vehicle 400 can be thereby maintained also in a lane in which disturbance is steadily applied such as the cant road.

Note that the integration process shown in FIG. 15 can be omitted.

### (Reference Line Recognition Process)

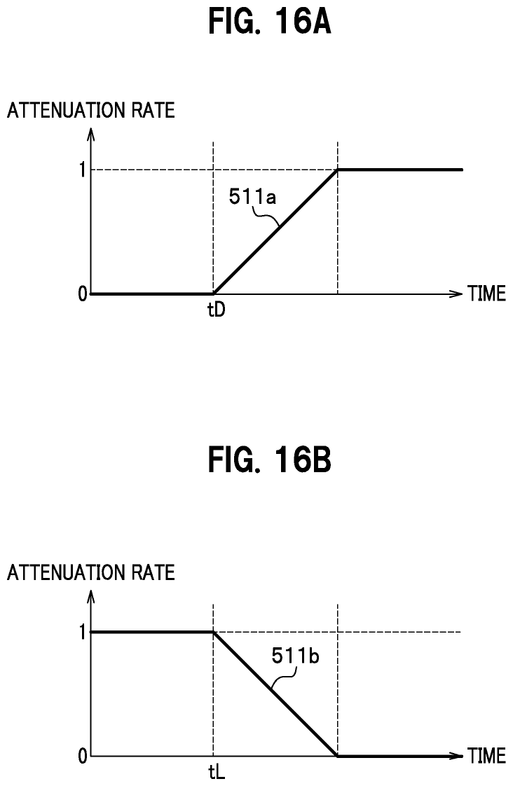

Next, the reference line recognition process is described with reference to FIGS. 16A and 16B.

FIGS. 16A and 16B are graphs explaining the reference line recognition process.

The vehicle controller 120 multiplies the offset ST by a varying value 511a based on FIG. 16A, based on the recognition result of the reference line LS based on the image of the camera 202 obtained by the reference line recognizer 110 (see FIG. 1).

Specifically, when the reference line recognizer 110 detects the reference line LS, the torque control based on the offset ST becomes gradually stronger. The torque control using the offset ST thereby does not suddenly start and the strangeness felt by the driver can be thus reduced.

Moreover, when the reference line recognizer 110 loses sight of the reference line LS, the vehicle controller 120 multiplies the offset ST by a varying value 511b based on FIG. 16B. Specifically, when the reference line recognizer 110 loses detection of the reference line LS that has been detected up to now, the vehicle controller 120 multiplies the offset ST by the varying value 511b based on FIG. 16B.

Performing such a process causes the torque control based on the offset ST to become gradually weaker when the reference line recognizer 110 loses sight of the reference line LS. This can prevent sudden stop of the torque control using the offset ST and the strangeness felt by the driver can be thus reduced.

### (Detailed Configuration of Vehicle Controller 120)

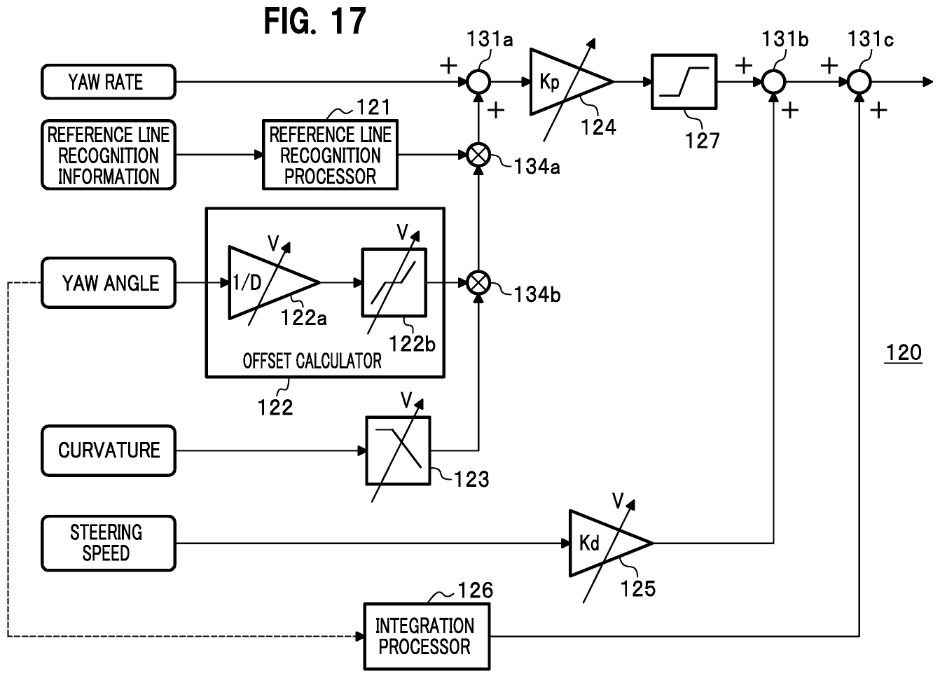

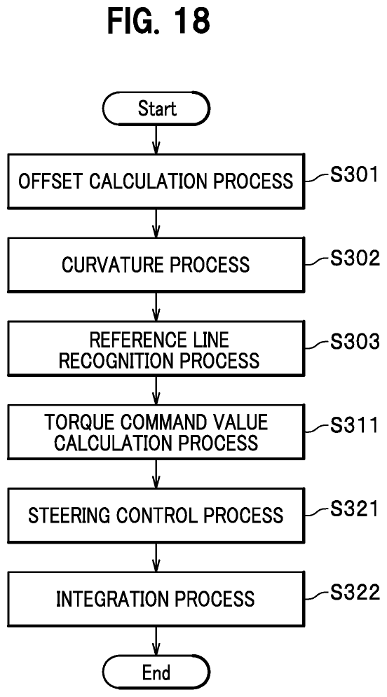

FIG. 17 is a diagram showing a detailed configuration of the vehicle controller 120 according to a first embodiment. FIG. 1 is referred to as appropriate. Moreover, FIG. 18 is a flowchart showing a procedure of processes performed by the vehicle controller 120.

The process performed by the vehicle controller 120 is described with reference to FIG. 18 as well as FIG. 17. Note that, in the following description, step numbers are the step numbers in FIG. 18. Moreover, the flowchart of FIG. 18 is a detailed flowchart of the process of step S3 in FIG. 2.

As shown in FIG. 17, the vehicle controller 120 includes a reference line recognition processor 121, an offset calculator 122, a curvature processor 123, a torque command value calculator 124, an upper lower limit part 127, a steering angular velocity processor 125, and an integration processor 126. Moreover, the offset calculator 122 includes a distance divider 122a and a speed multiplier 122b. Furthermore, the vehicle controller 120 includes adders 131a to 131c and multipliers 134a and 134b.

The offset calculator 122 obtains the yaw angle of the vehicle 400 calculated by the calculator 140 based on the video captured by the camera 202. Then, the offset calculator 122 causes the distance divider 122a to divide the yaw angle by the distance D (see FIG. 7) from the current position of the vehicle 400 to the front interest point GP (see FIG. 7). Then, the speed multiplier 122b multiplies the result of the distance divider 122a by the current vehicle speed V and also provides a dead band. The offset calculator 122 thus performs an offset calculation process (S301) of calculating the offset ST of the formula (1). The reason that the dead band is provided in the speed multiplier 122b is as follows. Since the yaw angle (θ) included in the formula (1) is based on a signal originating from the video captured by the camera 202, there is a potential of noise generation in the yaw angle.

The curvature processor 123 performs a curvature process of outputting the attenuation rate shown in FIGS. 11 to 12C based on the curvature (S302). The multiplier 134b multiplies the offset ST by the outputted attenuation rate.

Moreover, the reference line recognition processor 121 performs the reference line recognition process of outputting the varying values 511a or 511b shown in FIGS. 16A and 16B based on reference line recognition information received from the reference line recognizer 110 (see FIG. 1) (S303). The multiplier 134a multiples the offset ST by the outputted varying value 511a or 511b.

Next, in the adder 131a, the offset ST outputted from the multiplier 134a is added to the yaw rate of the vehicle 400 obtained from the yaw rate sensor 201. Note that, since the offset ST has the dimension of the yaw rate as shown in the formula (1), the addition by the adder 131a is possible.

Then, the torque command value calculator 124 multiplies the output of the adder 131a by the gain shown in the solid line L1 of FIG. 6 to perform the torque command value calculation process of outputting the torque command value 241 (S311). Note that the upper lower limit part 127 provides the upper and lower limits for the output of the torque command value calculator 124 (±MT in FIG. 6).

In this example, the torque command value 241 is outputted based on the solid line L1 of FIG. 6 and the value obtained by adding the offset ST to the yaw rate obtained from the yaw rate sensor 201. This process is the same as the process of translating the solid line L1 to the broken line L2a or the broken line L2b in FIG. 6 and outputting the torque command value 241 based on the translated solid line L1 and the yaw rate obtained from the yaw rate sensor 201. Specifically, the torque command value calculation process described in FIG. 18 provides the same result as the torque command value calculation process described with reference to FIG. 6.

The steering angular velocity processor 125 performs a steering control process of outputting the attenuation torque command value (broken line L12 of FIG. 13) for the steering angular velocity (solid line L11 of FIG. 13) (S321). The adder 131b adds the attenuation torque command value (broken line L12 of FIG. 13) outputted from the steering angular velocity processor 125 shown in FIG. 17, to the torque command value 241 outputted from the torque command value calculator 124.

Then, the integration processor 126 performs the integration process of outputting the integration information obtained by integrating the yaw angle as shown in the graph G21 of FIG. 15 and adding the predetermined gain to the integrated yaw angle (S322). The gain is a negative value as described above. The adder 131c adds the integration information outputted from the integration processor 126 to the torque command value 241 outputted by the adder 131b.

Then, the torque command value 241 outputted from the adder 131c is outputted to the steering controller 150 shown in FIG. 1.

In the embodiment, the torque command value 241 is set to reduce the yaw angle being the angle formed between the vehicle 400 and the reference line LS. This allows the vehicle 400 to be directed in the direction parallel to the reference line LS even when the disturbance 301 occurs.

Moreover, in the embodiment, the yaw rate that causes the vehicle 400 to be parallel to the reference line LS at the moment when the vehicle 400 reaches the front interest point GP is set as the target value, and this enables simple calculation of the torque command value 241. Furthermore, using the yaw angle and the yaw rate obtained from the yaw rate sensor 201 enables easy calculation of the torque command value 241 that causes the vehicle 400 to be parallel to the reference line LS.

### Second Embodiment

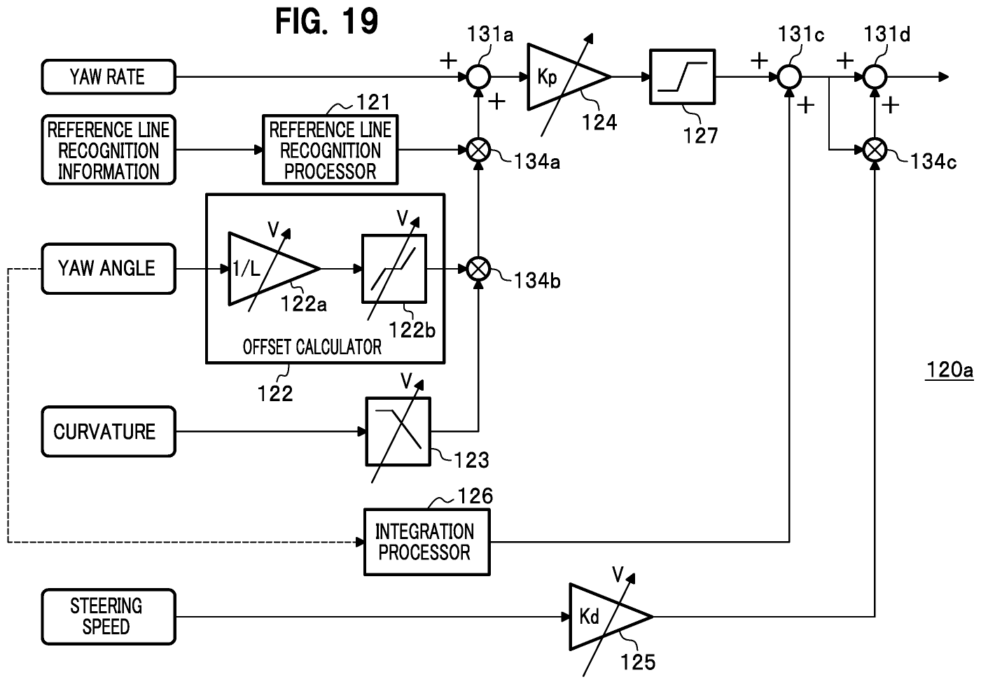

FIG. 19 is a diagram showing a detailed configuration of a vehicle controller 120a according to a second embodiment.

In FIG. 19, configurations similar to those in FIG. 17 are denoted by the same reference numerals and description thereof is omitted.

First, as shown in FIG. 19, the configuration is similar to that in FIG. 17 up to the output of the torque command value 241 by the upper lower limit part 127. Then, the adder 131c adds the output of the integration processor 126 to the torque command value 241.

Next, a multiplier 134c multiplies the torque command value 241 outputted from the adder 131c by the attenuation torque command value outputted from the steering angular velocity processor 125. Then, an adder 131d adds up the output of the multiplier 134c and the torque command value 241 outputted from the adder 131c.

In such a configuration, the attenuation torque command value outputted from the steering angular velocity processor 125 is added to the torque command value 241 when the torque command value 241 outputted from the upper lower limit part 127 is not “0”. Specifically, the control using the attenuation torque command value (broken line L12) shown in FIG. 13 is performed only when the torque command value 241 is outputted. Moreover, the smaller the torque command value 241 is, the smaller the control using the attenuation torque command value is, and the larger the torque command value 241 is, the larger the control using the attenuation torque command value is.

When the attenuation torque command value outputted by the steering angular velocity processor 125 is always added to the torque command value 241, the control using the attenuation torque command value may be performed also in a situation where the control using the attenuation torque command value is unnecessary. For example, the control using the attenuation torque command value may affect the operation of the steering wheel (not shown) by the driver. When such control is performed, feeling degradation may occur.

According to the vehicle controller 120a shown in FIG. 19, the control using the attenuation torque command value is performed only in a situation where the torque command value 241 generated by the occurrence of the disturbance 301 is outputted. Performing such a process can prevent the control using the attenuation torque command value in the situation where the control is unnecessary. This can reduce the feeling degradation.

What is claimed is:

1. A vehicle control device comprising:
a camera that captures a vehicle forward-view image;
a reference line recognizer that recognizes at least one reference line and a yaw angle of a host vehicle with respect to the reference line from the vehicle forward-view image;
a recovery yaw rate calculator that calculates a recovery yaw rate which generates a yaw in such a direction that the yaw angle with respect to the reference line decreases as the yaw angle increases; and
a steering controller that controls the yaw of the vehicle depending on the recovery yaw rate.

2. The vehicle control device according to claim 1, wherein the recovery yaw rate is set depending on vehicle speed and a distance to a front interest point.

3. The vehicle control device according to claim 2, wherein the recovery yaw rate is changed depending on a curvature of a lane.

4. The vehicle control device according to claim 3, wherein the recovery yaw rate is changed depending on the vehicle speed.

5. The vehicle control device according to claim 1, wherein the recovery yaw rate calculator further adds an attenuation torque depending on steering speed, to the recovery yaw rate.

6. The vehicle control device according to claim 5, wherein the recovery yaw rate calculator outputs the attenuation torque only when a control value obtained by using the recovery yaw rate is outputted.

7. The vehicle control device according to claim 1, wherein the recovery yaw rate calculator adds a value, obtained by multiplying a result of time integration of the yaw angle of the vehicle by a predetermined gain, to the recovery yaw rate.

8. The vehicle control device according to claim 1, wherein the recovery yaw rate calculator
gradually increases the recovery yaw rate when the reference line recognizer detects the reference line, and
gradually reduces the recovery yaw rate when the reference line recognizer loses detection of the reference line that has been detected up to now.

9. A vehicle in which the vehicle control device according to claim 1 is mounted.
